(19) United States
(12) Patent Application Publication
(10) Pub. No.: US 2010/0129614 A1
(43) Pub. Date: May 27, 2010

(54) LOW-DENSITY STRUCTURAL PANEL MADE FROM USED PAPER MATERIAL, AND PROCESS FOR MAKING SAME

(75) Inventors: John Whitehead, Hartsville, SC (US); Myles Cohen, Columbia, SC (US); Lawrence E. Renck, Hartsville, SC (US); Terry Gerhardt, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SONOCO DEVELOPMENT, INC., Hartsville, SC (US)

(21) Appl. No.: 12/595,323

(22) PCT Filed: May 8, 2008
(86) PCT No.: PCT/US2008/063024

§ 371 Date: Oct. 9, 2009

Related U.S. Application Data
(60) Provisional application No. 60/939,190, filed on May 21, 2007.

(51) Int. Cl. E04C 2/16; B27N 3/08; B32B 3/28; B32B 37/12; B32B 5/00

(52) U.S. Cl. 428/184; 264/109; 264/101; 156/62.2; 264/112; 156/242

(57) ABSTRACT

A low-density structural panel is made from used paper material such as shredded or divided old corrugated containers (OCC). The pieces of used paper material are mixed with an adhesive and the mixture is formed into a layer. The layer is compressed with a compression device to reduce its thickness and increase its density. The layer is heated to hasten the hardening of the adhesive. The process can be a batch process or a continuous process.

### BACKGROUND OF THE INVENTION

The present disclosure relates generally to structural panels made of fibrous materials such as paper materials.

Paperboard containers made from corrugated or non-corrugated paperboard are widely used for shipping products from manufacturers or distributors to retailers and other destinations. Other paper materials such as newsprint for advertising flyers, paper used as cushioning in cartons, and the like, are also widely used in industry. Once the paper materials have been used for their intended purpose, they are generally regarded as waste. In some cases, the used paper materials are simply disposed of along with other waste. In other cases, the recipient of the used paper materials may send the used paper materials to a recycler, at which the used paper materials are shredded and/or baled and then shipped to a paper mill. The paper mill can repulp the used paper materials to make recycled paper, which can then be converted into products of various types.

However, these recycling steps add significant cost to a material that is already of relatively low commercial value.

### BRIEF SUMMARY OF THE DISCLOSURE

The present disclosure concerns a process for making a low-density structural panel from used paper material such as corrugated paperboard material. In accordance with one aspect of the disclosure, a process is described for making a low-density structural panel, comprising the steps of:
providing used paper material that has been divided into pieces;
distributing an adhesive through the pieces of used paper material such that substantially all of the pieces have at least some adhesive thereon;
forming a layer of the adhesive-covered pieces;
contacting the layer of adhesive-covered pieces with a compression device so as to compress the layer to a smaller thickness and increase the density of the layer; and
heating the layer to dry and harden the adhesive so as to form a low-density structural panel.

The process can be either a batch-type process in which one panel at a time is produced, or a continuous process in which a continuous low-density structural panel is produced and is subsequently cut into desired lengths. A batch process can entail using a mold configured to impart the desired shape to the panel. After the pieces of paper material have been mixed with the adhesive, the mixture is deposited into the mold. A suitable compression device is then used to compress the mixture in the mold. The compression step can be performed with or without heating. After compression, the mold is opened and the panel is removed. The panel can then be heated in an oven to dry and harden the adhesive.

The continuous process can entail a number of different embodiments. In one embodiment, the forming step comprises continuously depositing the adhesive-covered pieces onto a moving conveyor to form a continuous layer of the adhesive-covered pieces. The contacting step comprises contacting the layer of adhesive-covered pieces being advanced by the moving conveyor with a compression device so as to compress the layer to a smaller thickness and increase the density of the layer. The heating step comprises heating the layer to dry and harden the adhesive so as to form a continuous low-density structural panel.

In one embodiment, the distributing step comprises mixing the pieces with a silicate-based adhesive.

The continuously depositing step can comprise using a headbox to continuously discharge the pieces onto the moving conveyor. Additionally or alternatively, the continuously depositing step can comprise using a metering spreader to spread the pieces on the moving conveyor at a generally controlled volumetric rate.

In some embodiments, the moving conveyor comprises a moving perforated screen or belt arranged in a loop about rotating rollers, the screen or belt being backed up by a platen. The contacting step comprises contacting the layer with a second moving perforated screen or belt arranged in a loop about rotating rollers and backed up by a second platen, the second screen or belt with the second platen being urged against the layer to compress the layer on the moving conveyor. At least one of the platens can be perforated and vacuum can be applied therethrough for facilitating draining of liquid from the layer.

In another embodiment, the distributing step comprises carrying a layer of the pieces on the moving conveyor through a bath of the adhesive, the moving conveyor comprising a perforated screen or belt and the layer being retained between the moving conveyor and a second moving perforated screen or belt.

The process can also include adhering a continuous paper web to one surface of the continuous low-density structural panel. In one embodiment, the moving conveyor comprises the continuous paper web, the paper web becoming adhered to one surface of the layer and forming a first surface of the low-density structural panel. Alternatively, the paper web can be adhered to the layer after the layer has been heated to dry and substantially harden the adhesive. The process can also include adhering a second continuous paper web to the opposite surface of the continuous low-density structural panel.

In one variation, the paper web is adhered to the surface of the low-density structural panel using only the adhesive applied previously in the distributing step. Alternatively, the paper web can be adhered to the surface after an application of additional adhesive to the paper web or to the surface of the low-density structural panel.

In accordance with another aspect of the present disclosure, a low-density structural panel is described, comprising a network of individual pieces of corrugated cardboard material arranged in random orientations with respect to one another and bound together by an adhesive, the pieces being less than about 50 in² in size. By “panel” is meant a structural member in which at least one of a length and a width of the member substantially exceeds a thickness of the member. Thus, “panel” can include items such as boards, sheets, planks, and the like, having various cross-sections that may or may not be uniform along the length and/or width.

In some embodiments, at least a portion of the pieces making up the panel comprise strips of the corrugated cardboard material, the strips having an average length-to-width ratio (or “aspect ratio”) greater than about 5, in some cases greater than about 10, and in some cases greater than about 15.

In some embodiments, the strips are cut from corrugated cardboard material such that a length of each strip extends perpendicular to a direction in which flutes of the corrugated cardboard material extend, such that each strip has a plurality of cells defined by the flutes, the adhesive infiltrating into at least some of the cells of the strips.

In preferred embodiments, substantially all of the pieces making up the network comprise the strips. The strips can have an average width of about ⅛-inch to about ½-inch and an average length of about 2 inches to about 6 inches.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a photograph of pieces of shredded paper material in which the pieces are randomly shaped and of a variety of sizes ranging from particles to about 1 in² in size, in accordance with one embodiment of the invention;

FIG. 2 is a photograph of a mold useful for practicing a batch process for making a panel in accordance with one embodiment of the invention;

FIG. 3 is a photograph of a grid device in which the panel, after being removed from the mold, is held for heating of the panel in an oven;

FIG. 4 is a photograph of the completed panel;

FIG. 5 is a close-up photograph of a portion of the panel of FIG. 4;

FIGS. 6 through 8 are photographs of a panel made from a second type of paper material comprising long narrow strips of old corrugated containers;

FIG. 9 is a diagrammatic illustration of a continuous process for producing panels in accordance with one embodiment of the invention;

FIG. 10 is a diagrammatic illustration of a continuous process for producing panels in accordance with another embodiment of the invention; and

FIG. 11 is a diagrammatic illustration of a continuous process for producing panels in accordance with yet another embodiment of the invention.

### DETAILED DESCRIPTION OF THE INVENTION

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

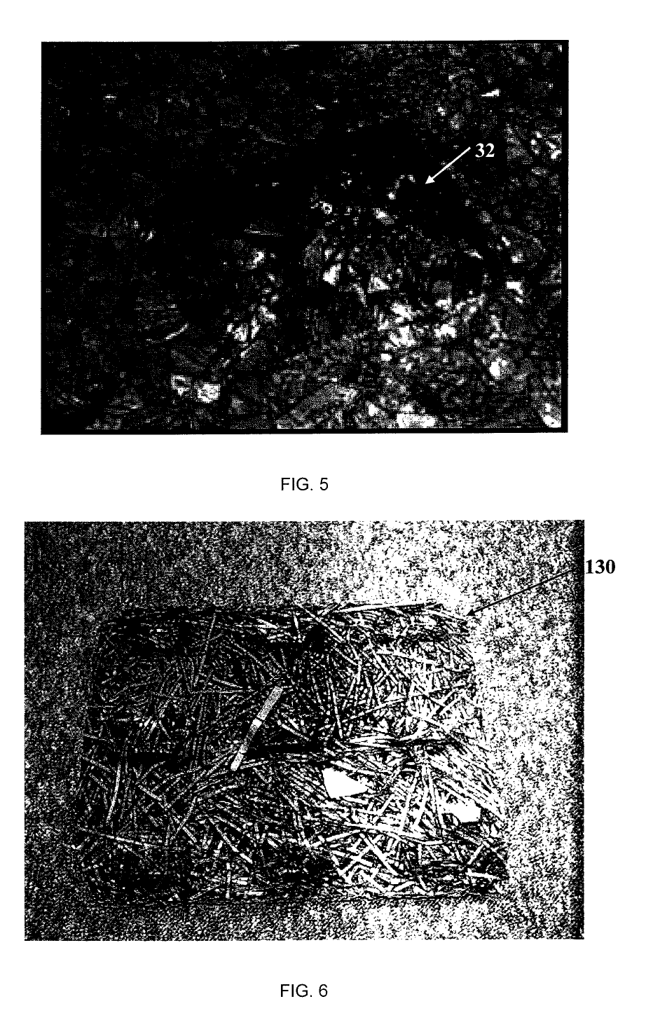

A batch process for making panels in accordance with the present invention is first described with reference to FIGS. 1 through 8. In FIG. 1 is shown a quantity of shredded old corrugated container (OCC) material that can be used in accordance with the invention. A ruler having inch marks is depicted alongside the material for scale. The pieces of OCC range from small particles to pieces of about 1 in² size. In accordance with one batch process for making a panel in accordance with the invention, a quantity of this shredded material is thoroughly mixed with a suitable adhesive such that substantially all of the pieces are at least partially coated with the adhesive. Any of various adhesives can be used. Aqueous adhesives are a suitable choice because they are easy to work with and do not have the environmental hazard issues that are associated with some solvent-based adhesives. As one example, the adhesive can comprise a silicate-based adhesive such as a sodium silicate adhesive. A suitable solution, for example, has 4 parts of a 38 wt. % solids silicate solution of 42° Be (having a sodium/silicate ratio of 3.22) to one part water. This solution is approximately 30 wt. % solids.

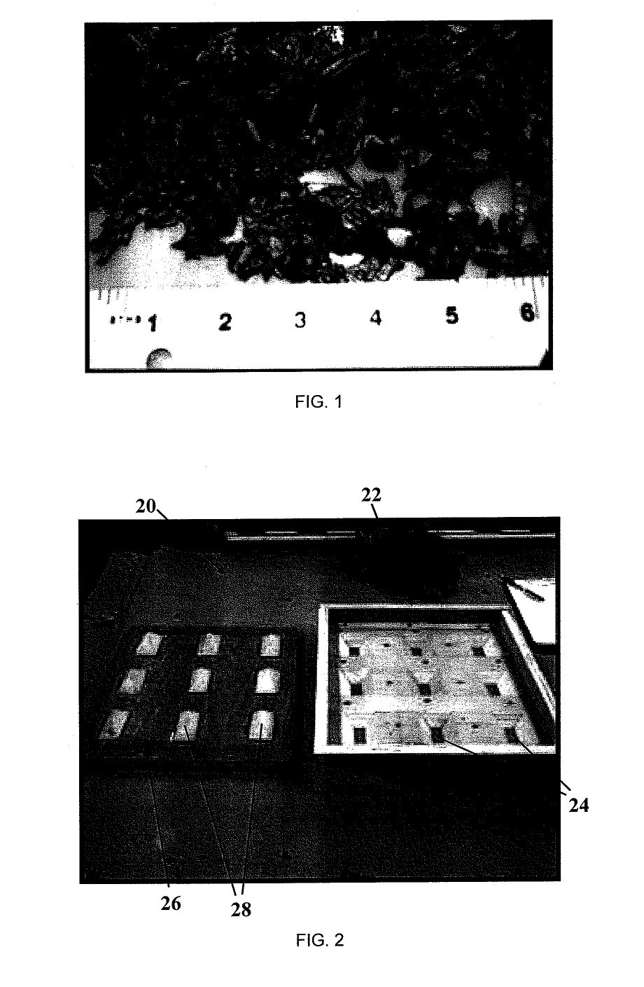

FIGS. 2 through 5 illustrate the formation of a panel using the mixture of FIG. 1 with the 30 wt. % solids silicate adhesive solution described above. After the pieces of OCC were thoroughly mixed with the adhesive solution, the mixture was poured into the bottom member 22 of a mold 20 depicted in FIG. 2. The mold was configured to produce a rectangular panel having a length of about 15 inches and a width of about 12 inches, and a thickness of about 1 inch. The bottom mold member 22 was configured with a series of spaced recesses 24 for forming a plurality of spaced “feet” on the panel's lower surface. The top mold member 26 comprised a flat plate having a plurality of protrusions 28 shaped to complement the recesses in the bottom mold member such that the upper surface of the panel is formed to have depressions at the locations of the feet. The protrusions 28 help to compress the material in the feet so that the feet have sufficient density and strength.

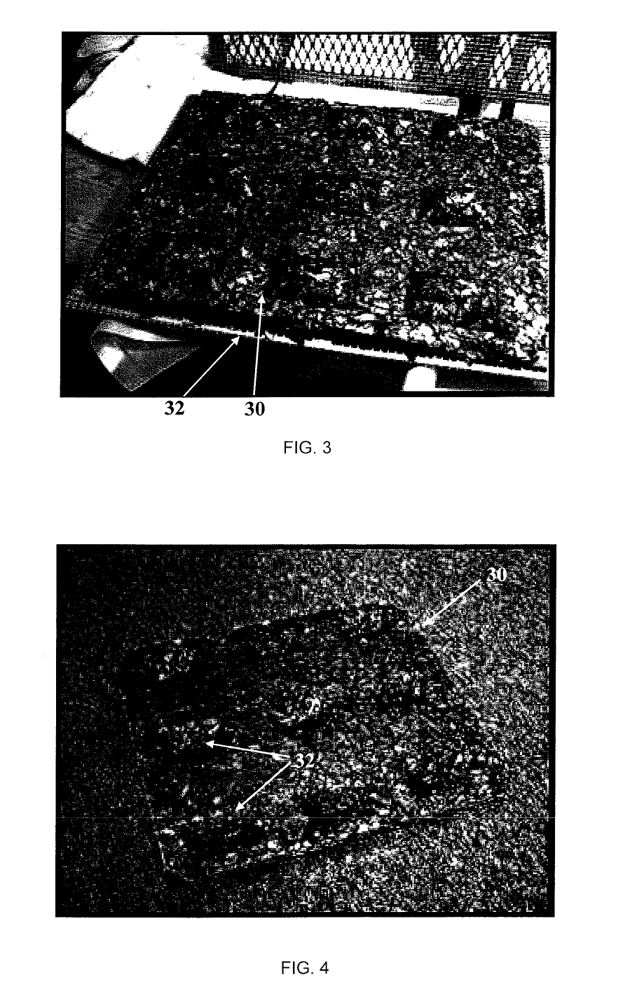

Once the bottom mold member 22 was filled with an appropriate quantity of the OCC/adhesive mixture and the mixture was spread out into a substantially uniform-thickness layer, the top mold member 26 was placed atop the layer. The mold was then placed into a hydraulic press and a pressure of about 10 tons was applied (without heating) for about 15 minutes. The mold was then removed from the press and was opened, and the partially hardened panel 30 was removed from the mold. As shown in FIG. 3, the partially hardened panel 30 was then placed on a metal grid 32. Another grid 34 was placed atop the panel to reduce warping of the panel, and this assembly was placed into an oven to substantially fully harden the adhesive. The mold was removed from the oven and the panel 30 was removed from the mold. FIG. 4 illustrates the feet 32 formed on the lower surface of the panel 30. FIG. 5 shows one of the feet 32 in close-up.

FIGS. 5 through 8 depict a second panel 130 formed by the same process described above, but using a mixture of long narrow strips of OCC mixed with the silicate adhesive solution previously described. The strips had an average width of about ⅛-inch and an average length of about 4 inches. The strips were cut such that their length direction was perpendicular to the direction in which the flutes of the OCC extended. Accordingly, each strip had a plurality of “cells” formed by the flutes, the cells being open at the opposite long edges of the strip. When the strips were mixed with the adhesive, some of the adhesive was able to penetrate into the cells of the strips, and it is theorized this provides a reinforcing effect after the adhesive hardens, enhancing the strength properties of the panel. The long narrow strips form a network or matrix similar to cellulose fibers in paper but on a larger scale. This matrix allows the panel to have a significantly lower density (½ to ⅓ that of the panel produced from shredded OCC) while still retaining structural strength and integrity.

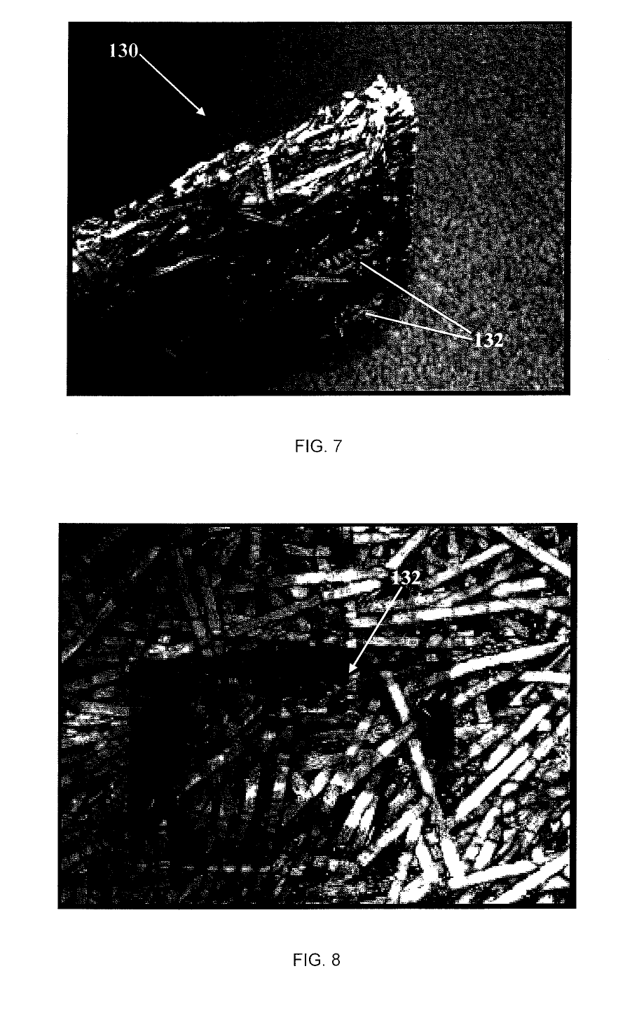

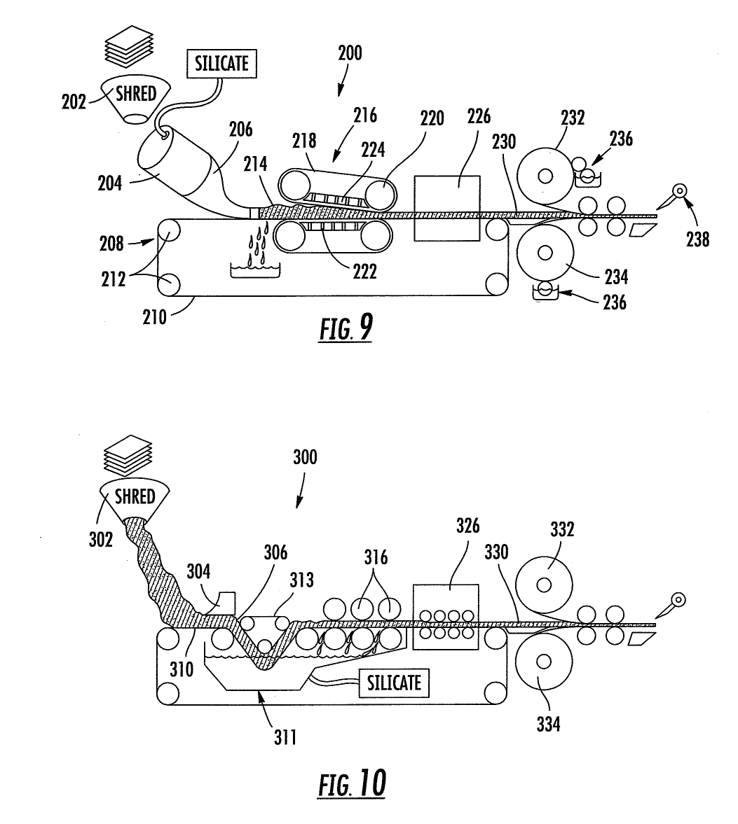

FIGS. 7 and 8 are additional views of the panel 130. The lower surface has feet 132 as in the previous embodiment.

The process of the invention can also be practiced as a continuous process. FIG. 9 shows an apparatus 200 and process for producing a continuous low-density structural panel in accordance with an embodiment of the invention. The apparatus includes a shredder 202 or other device for dividing OCC or other used paper materials into pieces. The shredding is shown as being performed inline with the rest of the process, but alternatively shredding can be done offline at an adjacent or a remote location, and the shredded material can be held in a hopper (not shown) and dispensed from the hopper in any suitable fashion. The shredded material is mixed with adhesive in a mixing device 204. This mixture is continuously discharged from a headbox 206 or similar device onto a moving conveyor 208 comprising a foraminous (perforated) belt or screen 210 formed as an endless loop and guided by a plurality of rollers 212 one or more of which is rotatably driven by a suitable motor (not shown) such that the belt 210 continuously rotates for transporting the mixture discharged from the headbox. The headbox meters the mixture being discharged so that the layer 214 of material on the belt 210 has a generally uniform thickness of a desired value. The belt 210 allows excess adhesive solution to drain through the belt as shown.

The layer 214 is carried on the conveyor belt 210 through a compression device 216 comprising the belt 210 cooperating with a foraminous second belt or screen 218 formed as an endless loop about rollers 220 at least one of which is rotatably driven so the second belt 218 travels with the same linear speed as the conveyor belt 210. The compression device includes a first platen 222 that backs up the conveyor belt 210 and that is perforated, and a second perforated platen 224 that backs up the second belt 218. The second belt 218 and second platen 224 are urged toward the conveyor belt 210 and first platen 222 by a suitable actuator (not shown) so as to compress the layer 214 of paper/adhesive on the conveyor belt. As shown, suction can be exerted through either or both platens to assist in removing excess adhesive solution from the layer. The compression device reduces the thickness and increases the density of the layer 214 on the conveyor belt.

After the compression device, the conveyor belt 210 carries the layer 214 through an oven 226 or other suitable heating device to hasten the drying and hardening of the adhesive. A continuous low-density structural panel 230 is discharged from the oven. If desired, a continuous paper web 232 can be applied to one surface of the panel 230 and a second continuous paper web 234 can be applied to the opposite surface of the panel. In some cases, the adhesive present at the surfaces of the panel may suffice for adhering the paper webs. In other cases, adhesive can be applied to the paper webs (or to the surfaces of the panel) by suitable adhesive applicators 236 as shown. The finished panel can then be cut into desired lengths by a suitable cutting device 238.

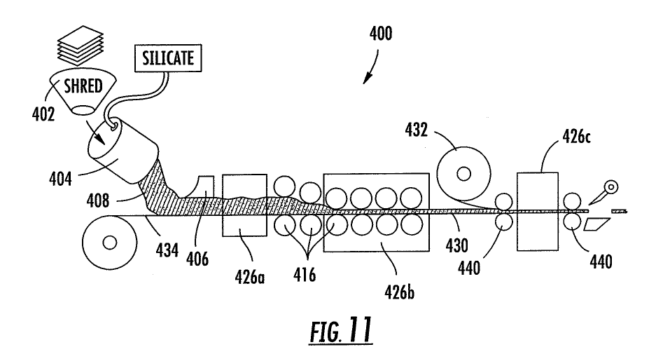

An alternative apparatus 300 and process in accordance with another embodiment of the invention are shown in FIG. 10. A shredder 302 divides the OCC/paper material into pieces. A metering spreader 304 spreads the pieces in a substantially uniform-thickness layer 306 on a moving conveyor belt or screen 310. The conveyor belt carries the layer 306 into a reservoir 311 of adhesive. The layer is retained between the conveyor belt 310 and a second belt or screen 313 that contacts the upper surface of the layer. The conveyor belt 310 carries the adhesive-impregnated layer through a series of nip rollers 316 that compress the layer and squeeze excess adhesive out of the layer. Excess adhesive drains through the foraminous conveyor belt 310 back into the reservoir 311. The layer is then carried on the conveyor belt 310 through an oven 326 to hasten the hardening of the adhesive. Continuous paper webs 332, 334 are applied to the opposite surfaces of the continuous low-density structural panel 330 discharged from the oven, and the finished panel is cut into desired lengths as in the previous embodiment.

Yet another apparatus 400 and process in accordance with a further embodiment of the invention are shown in FIG. 11. A shredder 402 divides the OCC/paper material into pieces. The pieces are mixed with adhesive in a mixer 404 and the mixture is deposited onto a moving continuous paper web 434 that functions as a conveyor for moving the layer of the mixture through the various stages of the process. A metering spreader 406 spreads the mixture in a substantially uniform-thickness layer 408 on the paper web 434. The paper web 434 carries the layer through a first oven 426a, which partially dries and hardens the adhesive. The paper web then carriers the layer through a series of nip rollers 416 that compress the layer and increase its density. The layer is then carried on the paper web 434 through a second oven 426a to substantially complete the hardening of the adhesive. A continuous paper web 432 is applied to the top surface of the continuous panel 430 discharged from the second oven. If desired or needed, additional post-heating can be performed with a third oven 426c and further compression of the panel can be accomplished with nip rollers 440 to further densify the panel. The panel can then be cut into desired lengths.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A process for making a low-density structural panel comprising the steps of:
providing used paper material that has been divided into pieces;
distributing an adhesive through the pieces of used paper material such that substantially all of the pieces have at least some adhesive thereon;
forming a layer of the adhesive-covered pieces;
contacting the layer of adhesive-covered pieces with a compression device so as to compress the layer to a smaller thickness and increase the density of the layer; and
causing or allowing the adhesive to dry or cure, so as to form a low-density structural panel.

2. The process of claim 1, comprising a process for continuously making a low-density structural panel, wherein:
the forming step comprises continuously depositing the pieces onto a moving conveyor to form a continuous layer of the pieces;
the contacting step comprises contacting the layer of adhesive-covered pieces being advanced by the moving conveyor with a compression device so as to compress the layer to a smaller thickness and increase the density of the layer; and
the causing or allowing step comprises heating the layer to dry and harden the adhesive so as to form a continuous low-density structural panel.

3. The process of claim 1, wherein the distributing step comprises mixing the pieces with a silicate-based adhesive.

4. The process of claim 2, wherein the continuously depositing step comprises using a headbox to continuously discharge the pieces onto the moving conveyor.

5. The process of claim 2, wherein the continuously depositing step comprises using a metering spreader to spread the pieces on the moving conveyor at a generally controlled volumetric rate.

6. The process of claim 2, wherein at least some heating of the layer is performed prior to the contacting step.

7. The process of claim 6, wherein additional heating of the layer is performed after the contacting step.

8. The process of claim 2, wherein the moving conveyor comprises a moving perforated screen or belt arranged in a loop about rotating rollers, the screen or belt being backed up by a platen, and the contacting step comprises contacting the layer with a second moving perforated screen or belt arranged in a loop about rotating rollers and backed up by a second platen, the second screen or belt with the second platen being urged against the layer to compress the layer on the moving conveyor.

9. The process of claim 8, wherein at least one of the platens is perforated and vacuum is applied therethrough for facilitating draining of liquid from the layer.

10. The process of claim 2, wherein the distributing step comprises carrying a layer of the pieces on the moving conveyor through a bath of the adhesive, the moving conveyor comprising a perforated screen or belt and the layer being retained between the moving conveyor and a second moving perforated screen or belt.

11. The process of claim 2, further comprising the step of:
adhering a continuous paper web to one surface of the continuous low-density structural panel.

12. The process of claim 11, further comprising the step of:
adhering a second continuous paper web to the opposite surface of the continuous low-density structural panel.

13. The process of claim 11, wherein the paper web is adhered to the surface of the low-density structural panel using only the adhesive applied previously in the distributing step.

14. The process of claim 11, wherein the paper web is adhered to the surface after an application of additional adhesive to the paper web or to the surface of the low-density structural panel.

15. The process of claim 11, further comprising the step of:
heating the low-density structural panel after adhering of the paper web.

16. The process of claim 2, wherein the moving conveyor comprises a continuous paper web, the paper web becoming adhered to one surface of the layer and forming a first surface of the low-density structural panel.

17. The process of claim 16, further comprising the step of:
adhering a second continuous paper web to the opposite surface of the layer so as to form a second surface of the continuous low-density structural panel.

18. A low-density structural panel, comprising:
a network of individual pieces of corrugated cardboard material arranged in random orientations with respect to one another and bound together by an adhesive, the pieces being less than about 50 in² in size, at least one of a length and a width of the panel substantially exceeding a thickness of the panel.

19. The low-density structural panel of claim 18, wherein at least a portion of the pieces making up the panel comprise strips of the corrugated cardboard material, the strips having an average length-to-width ratio greater than about 5.

20. The low-density structural panel of claim 19, wherein at least a majority of the pieces comprise the strips, and the strips have an average length-to-width ratio greater than about 10.

21. The low-density structural panel of claim 20, wherein the strips are cut from corrugated cardboard material such that a length of each strip extends perpendicular to a direction in which flutes of the corrugated cardboard material extend, such that each strip has a plurality of cells defined by the flutes, the adhesive infiltrating into at least some of the cells of the strips.

22. The low-density structural panel of claim 21, wherein substantially all of the pieces comprise the strips.

23. The low-density structural panel of claim 22, wherein the strips have an average length-to-width ratio greater than about 15.

24. The low-density structural panel of claim 22, wherein the strips have an average width of about ⅛-inch to about ½-inch and an average length of about 2 inches to about 6 inches.

25. The low-density structural panel of claim 18, wherein the adhesive comprises a silicate-based adhesive.

26. The low-density structural panel of claim 25, wherein the adhesive comprises a sodium silicate adhesive.
